(19) United States
(12) Patent Application Publication
(10) Pub. No.: US 2019/0071617 A1
(43) Pub. Date: Mar. 7, 2019

(54) PROCESS OF DECOLORATION OF OIL DERIVATIVES OF PLANT ORIGIN

(71) Applicant: Versalis S.p. A., San Donato Milanese (MI) (IT)

(72) Inventors: Agostina Anna RUGGIU, Sorso (SS) (IT); Cecilia GRADELLA, Goito (MN) (IT)

(73) Assignee: Versalis S.p. A., San Donato Milanese (MI) (IT)

(21) Appl. No.: 16/085,693

(22) PCT Filed: Mar. 30, 2017
(86) PCT No.: PCT/IB2017/051825

§ 371 Date: Sep. 17, 2018

(30) Foreign Application Priority Data
Mar. 31, 2016 (IT) 102016000033275

(51) Int. Cl. C11B 3/08

(52) U.S. Cl. CPC C11B 3/08

(57) ABSTRACT

The present invention relates to a process of decoloration of oil derivatives of plant origin. In particular, the present invention relates to a process of decoloration of oil derivatives of plant origin, comprising mixtures of butyl esters of medium-long chain fatty acids and oligomers thereof. The oil derivatives of plant origin thus obtained can be used for applications different from those in the traditional fields of tires, namely in those fields wherein the distinctive compositional characteristics of said derivatives are not sufficient if not also associated to suitable characteristics of color. Examples of such fields are, for example, those of the construction industry, paints, tanning industry.

The present invention relates to a process of decoloration of oil derivatives of plant origin.

In particular, the present invention relates to a process of decoloration of oil derivatives of plant origin, comprising mixtures of butyl esters of medium-long chain fatty acids and oligomers thereof.

The oil derivatives of plant origin thus obtained can be used for applications different from those in the traditional fields of tires, namely in those fields wherein the distinctive compositional characteristics of said derivatives are not sufficient if not also associated with appropriate characteristics of color. Examples of such fields are, for example, those of the construction industry, paints, tanning industry.

The preparation of carboxylic acids is described in the known art by the oxidative scission of plant oils. For example, U.S. Pat. No. 5,399,749 discloses a process in which organic molecules containing a structural unit of formula —HC═CH— are converted into two or more molecules containing a structural unit of formula —COOH by the reaction with ozone. Through the process of U.S. Pat. No. 5,399,749, for example, the oleic acid is converted into a mixture of azelaic and pelargonic acids.

In order to avoid the use of a toxic and hazardous reagent such as ozone, more recently processes which allows to obtain saturated monocarboxylic acids from unmodified plant oils containing triglycerides of unsaturated fatty acids were developed. For example, U.S. Pat. No. 8,222,438 discloses a process which comprises reacting the above-mentioned triglycerides of unsaturated fatty acids with an oxidising compound in the presence of a catalyst, in order to obtain a reaction intermediate wherein the olefinic double bond was oxidized and provides a vicinal diol; said intermediate is then reacted with oxygen in the presence of a catalyst, such that two carboxylic groups are formed by oxidation from the vicinal diol, thus providing a reaction product comprising saturated monocarboxylic acids and triglycerides of carboxylic acids having more than one acid function.

The reactions described in U.S. Pat. No. 8,222,438 in sequence, as batch process, can be carried out also in a continuous process, as described in US 2015/0005521 A1.

In particular, the process of US 2015/0005521 A1 comprises the same oxidation reactions of a plant oil comprising unsaturated carboxylic acids in two steps cited above and also provides a further step of separation and hydrolysis of the triglycerides of carboxylic acids having more than one acid function, in order to obtain said carboxylic acids with more than one acid function in the purified form by fractionated crystallization.

The mono- and dicarboxylic acids obtained from plant oils are used in the pharmaceutical and phyto-pharmaceutical industry, cosmetic industry and products for household care. Furthermore, some of them are constituents of the so-called biodegradable and compostable bioplastics, as well as being important intermediates in the manufacture of bio-lubricants.

It is important to note that by the processes described in U.S. Pat. No. 8,222,438 and US 2015/0005521 A1 a residue of the distillation of fatty acids comprising compounds characterized by free acid groups is obtained, which can be esterified with C₁-C₄ alcohols, preferably with n-butanol, thus allowing to obtain butyl esters of medium-long chain fatty acids and oligomers thereof having a high stability to hydrolysis and thermal oxidation.

These derivatives can be advantageously used as additives for production processes of rubber, and particularly as synthetic elastomer extender oils and as process oils for preparing elastomer blends.

For example, the U.S. Pat. No. 8,969,454 discloses an elastomer composition comprising at least one elastomer and at least one oil derivative of plant origin selected from one or more of the following:

a) a mixture of triglycerides comprising one or more of the following oligomeric structures:

R₄[O—C(O)—R₁—C(O)—O—CH₂—CH(OR₂)—CH₂]ₙ—O—R₃,

wherein R₁ is a C₂-C₂₂ alkylene, R₂ is selected from C₆-C₂₄ monocarboxylic acid residues or C₆-C₂₄ dicarboxylic acid residues, R₃ is selected from H, C₆-C₂₄ dicarboxylic acid residues and C₆-C₂₄ monocarboxylic acid residues, R₄ is an alkyl group, n is an integer higher than or equal to 2, wherein said C₆-C₂₄ dicarboxylic acid residues of R₂ and R₃, are esterified with monoalcohols, and wherein said mixture of triglycerides is characterized by a Number Average Molar Mass (Mn) comprised between 800 and 10000;

b) triglycerides of one or more long-chain carboxylic acids comprising at least one carboxylic acid containing adjacent hydroxyl groups;

c) esters of polyols with at least one C₆-C₂₄ monocarboxylic acid and at least one C₆-C₂₄ dicarboxylic acid, said esters being different from the triglycerides.

It is important to note that the derivatives described in U.S. Pat. No. 8,969,454 can be characterized by a very dark color. For example, the colorimetric analysis on a sample of some of these derivatives in accordance with a standard method confers to them a color of a level exceeding the maximum level of the Gardner scale.

The Gardner color scale comprises 18 standard color levels ranging from “light yellow” to “deep red”. It is widely used to establish the color of oils, paints, chemical compounds such as resins, lacquers, fatty acids, etcetera.

The Gardner scale level of a sample can be determined according to the standard methods known to the person skilled in the art, for example ASTM D1544-04, ISO 4630 or AOCS Tdla-64T.

For the aims of the present invention, a color of a level exceeding the maximum level of the Garner scale, therefore formally higher than 18, is defined “off the chart”.

Therefore, when the above-mentioned very dark oil derivatives of plant origin are subjected to colorimetric analysis according to any standard method known to the person skilled in the art, in order to assign to them a color level of the Gardner scale, they can be characterized by a “off the chart” color.

Within the elastomeric composition described in U.S. Pat. No. 8,969,454, the above described oil derivatives of plant origin act as extender oils, whose function explicates by improving rubber workability, reducing the mixing time, minimizing the amount of heat generated and maximizing the dispersion of the components, and at the same time by increasing cold elasticity and flexibility of the rubber after vulcanization.

In addition to the main use in the field of tires, the above-mentioned oil derivatives of plant origin can be used, for example, as high-stability lubricants, plasticizers for conventional plastics and bioplastics, components of polyurethane, etcetera.

Nevertheless, the application in fields different from those of tires is severely limited by the very dark color of these derivatives.

For example, some oil derivatives of plant origin could be advantageously used in the construction industry, having demonstrated, for example, to be excellent release agents, namely being able to facilitate and accelerate the process of detachment of formworks after concrete pouring and solidification. Unfortunately, their use is limited by the fact that they release their very dark color to the concrete and provide a permanent coloration on the handwork which is not appreciated.

Other possible applications successfully tested, for example in the field of resins (in green formulations for the manufacture of alkyd resins and polyester resins, in coil coating processes), adhesives, inks and coloring pastes, have not had to date a practical realization due to the predominant coloring effect by these derivatives on the other components used in the various applications.

A further field in which some of these oil derivatives of plant origin could be advantageously used is the tanning industry, for the manufacture of oils and leather finishing intermediates. Also in this case, the coloring of these derivatives make unsuitable the use on leathers with a color different from black.

Therefore, the Applicant considers the aim to identify a process of decoloration of oil derivatives of plant origin, in particular of derivatives with a very dark color (namely of a level exceeding the maximum level of the Gardner scale, namely “off the charts”), in order to extend their application field.

In the state of the art numerous methods of decoloration of plant oils are described. They are mostly used on plant oils intended for human nutrition.

For example, U.S. Pat. No. 4,443,379 discloses a process of decoloration of plant oils using compositions comprising acid-activated sub-bentonite clays and a minor part of Y zeolite.

Other clays commonly used for decoloring oils are montmorillonite, kaolinite and attapulgite (also known as Fuller's earth).

For example, U.S. Pat. No. 5,151,211, discloses a composition useful to remove colored impurities from triglycerides oils, which comprises a decoloring clay of the attapulgite-smectite type and a polycarboxilic acid with chelating function.

U.S. Pat. No. 4,781,864 instead describes a process for removing colored pigments from plant oils comprising the treatment of said oils with acid-activated amorphous silica.

It is known to the person skilled in the art that, in general adsorbents, such as, for example activated carbon, celite, alumina, can perform a decoloring effect through the bond with chromophore molecules (chapter “Dyes—Environmental Chemistry” in “Kirk-Othmer Encyclopedia of Chemical Technology”, IV Ed. 1993, vol. 8 pag. 753-783).

It is also known that some oxidizing or reducing agents can perform a decoloring effect on plant oils. Among them, for example, H₂O₂, NaClO, Na₂S₂O₄ can be used at various concentrations (chapter “Bleaching” in “Ullmann's Encyclopedia of Industrial Chemistry”, V Ed. 1985, vol. A 4, pag. 191-199).

Finally, it is known to the person skilled in the art the hydrotreating with hydrogen in the presence of catalyst of plant oils can cause some decoloration.

The Applicant therefore applied the above-mentioned methods known in the art in order to decolor, at least partially, said oil derivatives of plant origin, in particular derivatives with a color of a level exceeding the maximum level of the Gardner scale, so as to obtain derivatives having color characteristics “suitable” for applications in fields different from, for example, those of tires, namely in those fields wherein the distinctive compositional characteristics of said derivative are not sufficient if not also associated to suitable color characteristics.

For the aims of the present invention, in order to determine the effectiveness of the methods of decoloration, the standard method ASTM D1544-04 was used for determining the color of transparent liquids expressed in the Gardner scale, method known to the person skilled in the art.

As described below, the known methods of decoloration, applied to oil derivatives of plant origin, in particular to the derivatives having a color exceeding the maximum level of the Gardner scale, namely “off the chart”, showed to be ineffective since they did not determine any change to the color of said derivatives, which is maintained “off the chart”.

Surprisingly, the Applicant has now found an innovative process of decoloration, never previously described, nor suggested by the known art, based on the use of H₂O₂ in the presence of a suitable catalyst.

Therefore, it is an aim of the present invention to provide a process of decoloration of oil derivatives of plant origin.

An advantage of the present process is to allow the decoloration of oil derivatives of plant origin, also very dark oil derivatives, namely having a color exceeding the maximum level of the Gardner scale, which in such a way can be used also in those fields different from that of the tires, such as, for example, construction industry, paints and tanning industry, and generally in those fields in which the distinctive compositional characteristics of said derivatives are not sufficient if they are not also associated to suitable characteristics of color.

In addition, the present process of decoloration is capable of considerably improving the transparency characteristics of the oil derivatives of plant origin.

Advantageously, the present process does not provide nor require a dilution of the oil derivatives of plant origin in organic solvents.

A further advantage of the present process is that reagents which are toxic or harmful to the environment are not used.

Further characteristics and advantages of the present invention will be evident from the following detailed description and with reference to the attached FIGURE, which illustrates the general characteristics of the process according to some embodiments of the invention and integrates the description below.

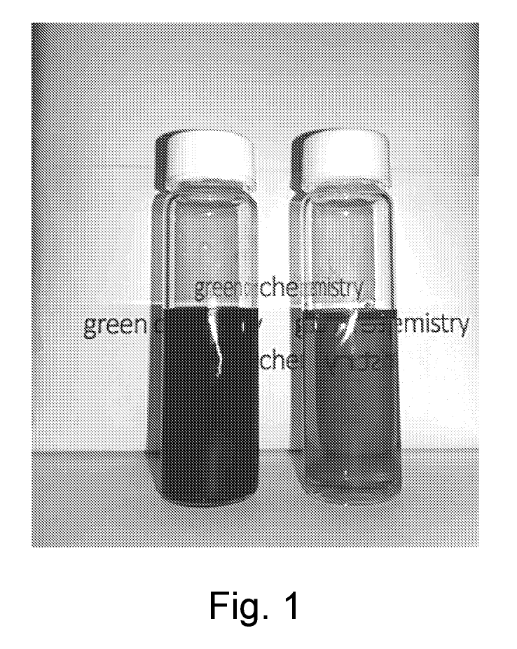

Particularly, FIG. 1 illustrates the comparison between two samples of an oil derivative of plant origin before and after the process according to the present invention, under the conditions described in example 1.

For the aims of the present description and the following claims, the definitions of the numeric ranges always comprise the end-points unless otherwise specified.

In the description of the embodiments of the present invention, the terms “comprising” and “containing” mean that the options described, for example relating the steps of a method or a process or the components of a product or a device, are not necessarily exhaustive. However, it is important to note that also the embodiments wherein the term “comprising” referred to the described options, for example those options relating the steps of a method or a process or the components of a product or a device, is to be interpreted as “consisting essentially of” or “consisting of”, represent an object of the present application, even if not explicitly declared.

For the aims of the present invention and the following claims, the percentages are always percentages by weight, unless otherwise specified.

For the aims of the present description, the derivatives that have color characteristics “suitable” for the applications in fields different from, for example, those of tires or bitumens, or in those fields in which the distinctive compositional characteristics of the oil derivatives of plant origin are not sufficient if not also associated to suitable color characteristics, are those derivatives characterized by a color within the Gardner scale, or derivatives which are characterized by a color of a level lower than or equal to 18 of said scale when subjected to a standard analytical method known to the person skilled in the art (for example ASTM D 1544-04, ISO 4630 or AOCS Tdla-64T).

The process of the present invention is particularly suitable for the decoloration of very dark oil derivatives of plant origin, which are not transparent, in particular the derivatives having a color of a level exceeding the maximum level of the Gardner scale.

However, said process can be successfully used also for decoloring oil derivatives of plant origin having colors comprised in the levels of said Gardner scale.

In such a case, through said process, starting from an oil derivative of plant origin having a color of any level of the Gardner scale, measured according to a standard method known to the person skilled in the art (for example ASTM D 1544-04, ISO 4630 or AOCS Tdla-64T) it is possible to obtain a plant oil derivative having a color of a level of said Gardner scale lower than the starting level.

Accordingly, for the aims of the present invention, the term “decoloration” means the transition of the color from a level of the Gardner scale to any lower level of said scale.

In particular, as for oil derivatives of plant origin having a color of a level exceeding the maximum level of the Gardner scale, namely a “off the chart” color, the term “decoloration” means the transition of said color from “off the chart” to any level of said scale.

Therefore, it is a first object of the present invention a process of decoloration of an oil derivative of plant origin, comprising the steps of:

i) reacting said oil derivative of plant origin with hydrogen peroxide in the presence of an oxidation catalyst at a temperature comprised in the range of 70° C.-100° C. in order to obtain a mixture comprising an aqueous phase and an oily phase;

ii) separating from said mixture the aqueous phase and the oily phase, the latter comprising a decolored oil derivative of plant origin.

According to a preferred aspect of the invention, the oily phase separated in step ii) consists of a decolored oil derivative of plant origin.

In a preferred aspect of the invention, step i) of said process can be carried out for a time comprised between 5 and 12 hours.

In a further preferred aspect of the invention, step i) of said process can be carried out for a time comprised between 6 and 10 hours, and even more preferably it is carried out for a time comprised between 7 and 9 hours.

In a preferred aspect, step i) can be carried out at a temperature comprised in the range of 80° C.-95° C.

According to another preferred aspect of the invention, said hydrogen peroxide in step i) is in the form of an aqueous solution, preferably having a concentration comprised between 20 and 70%, more preferably between 35 and 60% by weight of hydrogen peroxide with respect to the total weight of the aqueous solution.

In a preferred aspect of the invention, the step i) of said process can comprise the sub-steps of:

a) contacting said oil derivative of plant origin with an aqueous solution A comprising hydrogen peroxide, in the presence of an oxidation catalyst;

b) bringing the mixture obtained in the sub-step a) to a temperature comprised in the range of 70° C.-100° C.;

c) adding an aqueous solution B comprising hydrogen peroxide to the mixture obtained in the sub-step b);

d) maintaining the mixture obtained in the sub-step c), comprising an aqueous phase and an oily phase, at a temperature comprised in the range of 70° C.-100° C. for a time comprised between 5 and 12 hours.

Preferably, the step i) of the process according to the present invention can be carried out under stirring.

Preferably the sub-steps from a) to d) can be carried out under stirring.

Preferably, all the steps and/or sub-steps of the process of decoloration of the present invention are carried out without adding organic solvents.

The process of the present invention is effective not only for the decoloring effect, but also for considerably improving the transparency characteristics of the oil derivative of plant origin, and by virtue of this effect the color level can be assigned through any one of the standard methods (for example ASTM D 1544-04, ISO 4630 or AOCS Tdla-64T), specifically provided for transparent liquids.

In a preferred aspect of the invention, in order to attribute the color of the oil derivative of plant origin the Gardner color scale can be used.

As already mentioned, in order to attribute a level of the Gardner scale to the color of the plant oil derivative, it is possible to use any one of the methods known to the person skilled in the art, for example ASTM D1544-04, ISO 4630 or AOCS Tdla-64T. Preferably, in the process of the present invention, the Gardner scale level is attributed to the color of the oil derivative of plant origin by the standard method ASTM D1544-04.

In a preferred aspect of the invention, the above-mentioned oil derivative of plant origin which is reacted in step i) can have a color of a level higher than level 2 of the Gardner scale. More preferably the above-mentioned derivative can have a color of a level higher than level 5 of the Gardner scale and even more preferably a color of a level higher than level 13 of said scale.

According to a particularly preferred aspect of the invention, the above mentioned derivative can have a color of a level exceeding the maximum level of the Gardner scale.

Preferably, the oil derivative of plant origin can have a color of a level higher than level 13 of the Gardner scale or a “off the chart” color.

In a preferred aspect of the invention, when the oil derivative of plant origin has a color of a level exceeding the maximum level of the Gardner scale (namely, it is “off the chart”), the color of the decolored derivative at the end of the process can be of a level lower than or equal to level 18 of the Gardner scale and even more preferably it is of a level comprised between 13 and 18 of said scale.

Preferably, the oil derivative of plant origin can be any one of the derivatives described in U.S. Pat. No. 8,969,454, or comprises one or more from the following:

a) a mixture of triglicerides comprising one or more of the following oligomeric structures:

R₄[O—C(O)—R₁—C(O)—O—CH₂—CH(OR₂)—CH₂]ₙ—O—R₃,

wherein R₁ is a C₂-C₂₂ alkylene, R₂ is selected from C₆-C₂₄ monocarboxylic acid residues or C₆-C₂₄ dicarboxylic acid residues, R₃ is selected from H, C₆-C₂₄ dicarboxylic acid residues and C₆-C₂₄ monocarboxylic acid residues, R₄ is an alkyl group, n is an integer higher than or equal to 2, wherein said C₆-C₂₄ dicarboxylic acids residues of R₂ and R₃, are esterified with monoalcohols, and wherein said mixture of triglycerides is characterized by a Number Average Molar Mass (Mn) comprised between 800 and 10000;

b) triglycerides of one or more long-chain carboxylic acids comprising at least one carboxylic acid containing adjacent hydroxyl groups;

c) esters of poliols with at least one C₆-C₂₄ monocarboxylic acid and at least one C₆-C₂₄ dicarboxylic acid, said esters being different from triglycerides.

In a preferred aspect, the sub-step a) can be carried out at atmospheric pressure and at a temperature comprised in the range of 40° C.-65° C.

In a preferred aspect, during the sub-step a), said oil derivative of plant origin can be contacted with said aqueous solution A for a time comprised between 10 minutes and 1 hour, and more preferably for a time comprised between 15 minutes and 30 minutes.

The oxidation catalyst used in the process of the present invention belongs to the group of the transition elements. Advantageously Fe, Mn, Mo, Nb, Os, Re, Ti, V, W, Zr and acids thereof, alkaline salts and complexes, such as catalysts in homogeneous or heterogeneous phase, possibly in a supported or nanostructured form, are used.

In a preferred aspect of the invention, said oxidation catalyst can be selected from the group consisting of tungstic acid and phosphotungstic acid. Preferably, said catalyst is tungstic acid.

Said catalyst is preferably used in an amount comprised between 0.05% and 3% by weight, more preferably between 0.1% and 1.8% by weight with respect to the total weight of the oil derivative of plant origin to be decolored.

In a particularly preferred aspect, said catalyst is present in an amount comprised between 0.5 and 1.5% by weight with respect to the total weight of the derivative to be decolored.

The amount of hydrogen peroxide used in the present process can range depending on the titre of the solution used and can be comprised between 150 and 450 g of pure hydrogen peroxide (100%) per kg of oil derivative of plant origin.

In a preferred aspect of the present invention, the aqueous solution A and the aqueous solution B can comprise hydrogen peroxide at concentrations comprised between 20 and 70% by weight with respect to the total weight of the aqueous solution.

In further preferred aspect, the aqueous solution A and the aqueous solution B can comprise hydrogen peroxide at concentrations comprised between 35% and 60% and even more preferably at concentrations comprised between 45% and 55% by weight with respect to the total weight of the aqueous solution.

In a preferred aspect of the invention, the aqueous solution A which is contacted with the plant oil derivative during the sub-step a) of the process of the present invention can contain an amount of hydrogen peroxide comprised between 15% and 95% by weight with respect to the total weight of hydrogen peroxide added in the course of the whole process, and preferably comprised between 30% and 80%.

In a preferred aspect, during the sub-step c) the addition of the aqueous solution B can be carried out in a period of time comprised between 20 minutes and 5 hours.

More preferably, the addition of aqueous solution B in the course of sub-step c) is carried out in a period comprise between 30 minutes and 1 hour.

In a preferred aspect of the invention, the sub-step d) can be carried out for a time comprised between 6 and 10 hours, more preferably between 7 and 9 hours.

In a preferred aspect, the sub-step d) can be carried out at a temperature between 80° C. and 95° C.

The separation of the aqueous phase from the oily phase of step ii) of the above-mentioned process can be carried out by any method and device known by the person skilled in the art, which are intended to separate two heterogeneous phases from each other from a mixture comprising them.

For example, said separation can be carried out by separating funnel, or by a “florentine” type continuous separator.

It is a second object of the present invention an oil derivative of plant origin decolored by means of the above mentioned process of decoloration.

In a preferred aspect, said decolored oil derivative of plant origin has a color of a level equal to or lower than level 18 of the Gardner scale, and preferably it has a color of a level comprised between 13 and 18 of said scale.

Finally, it is a third object of the present invention an oil derivative of plant origin comprising one or more of the following:

a) a mixture of triglycerides comprising one or more of the following oligomeric structures:

R₄[O—C(O)—R₁—C(O)—O—CH₂—CH(OR₂)—CH₂]ₙ—O—R₃,

wherein R₁ is a C₂-C₂₂ alkylene, R₂ is selected from C₆-C₂₄ monocarboxylic acid residues or C₆-C₂₄ dicarboxylic acid residues, R₃ is selected from H, C₆-C₂₄ dicarboxylic acid residues and C₆-C₂₄ monocarboxylic acid residues, R₄ is an alkyl group, n is an integer higher than or equal to 2, wherein said C₆-C₂₄ dicarboxylic acid residues of R₂ and R₃, are esterified with monoalcohols, and wherein said mixture of triglycerides is characterized by a Number Average Molar Mass (Mn) comprised between 800 and 10000;

b) triglycerides of one or more long-chain carboxylic acids comprising at least one carboxylic acid containing adjacent hydroxyl groups;

c) esters of poliols with at least one C₆-C₂₄ monocarboxylic acid and at least one C₆-C₂₄ dicarboxylic acid, said esters being different from the triglycerides,

characterized by the fact of having a color of a level lower than or equal to level 18 of the Gardner scale and preferably a color of a level comprised between 13 and 18 of said scale.

In order to put into practise and better illustrate the present invention, some non-limiting examples are reported below.

### EXAMPLE 1 (DECOLORATION TEST OF AN OIL DERIVATIVE OF PLANT ORIGIN HAVING A COLOR OF A LEVEL EXCEEDING THE MAXIMUM LEVEL OF THE GARDNER SCALE, ACCORDING TO THE INVENTION)

400 g of an oil derivative of plant origin having a color of a level exceeding the maximum level of the Gardner scale were loaded into a flask of 1000 ml, which was equipped with magnetic stirring and a thermometer. Said oil derivative of plant origin is commercially available under the tradermark Matrilox™ PF801R and has a composition comprised between those of the derivatives described in U.S. Pat. No. 8,969,454. An aqueous solution, previously prepared (aqueous solution A) by mixing under stirring 4 g of tungstic acid (1% by weight with respect to the total weight of the treated plant oil derivative) and 120 g of hydrogen peroxide 50% by weight in water, was added to it.

In order to promote the homogenization of the reagents, the mixture thus obtained was maintained at 55-60° C. for 15 minutes under stirring.

Then, the mixture was heated at 80° C. and, by a dropping funnel, further 180 g of a solution of hydrogen peroxide 50% by weight in water (aqueous solution B) were added within 1 hour. Therefore, 375 g of hydrogen peroxide per kg of plant oil derivative in total were added.

At the end of the addition the reaction was left to proceed for further 7 hours by maintaining the temperature at 80° C. under stirring.

After this period of time, the separation of the oily phase and the aqueous phase was carried out by transfer into a separating funnel and settling.

Possible residues of aqueous phase containing hydrogen peroxide in the oily phase were removed through vacuum evaporation by means of rotating evaporator.

A sample of the obtained oily phase was subjected to colorimetric analysis in accordance with the standard method ASTM D 1544-04 and compared with a sample of the same starting oil derivative of plant origin. The Gardner scale level passed from the initial “off the chart” (level exceeding the maximum level of the Gardner scale) to level 13 of said scale, suitable for applications in fields different from the field of tires.

FIG. 1 represents a sample of oil derivative of plant origin before and after the decoloration treatment under the conditions of example 1.

### EXAMPLE 2 (DECOLORATION TEST OF AN OIL DERIVATIVE OF PLANT ORIGIN HAVING A COLOR OF A LEVEL EXCEEDING THE MAXIMUM LEVEL OF THE GARDNER SCALE, ACCORDING TO THE INVENTION)

In this example the process of example 1 was repeated by using however lower amounts of oxidizing reagent.

250 g of Matrilox™ PF801R previously described were loaded into a flask of 500 ml, which was equipped with stirring and a thermometer. An aqueous solution, previously prepared (aqueous solution A) by mixing under stirring 1.5 g of tungstic acid (0.6% by weight with respect to the total weight of the treated plant oil derivative) and 40 g of hydrogen peroxide 50% by weight in water, was added to it.

In order to promote the homogenization of the reagents, the mixture thus obtained was maintained at 55-60° C. for 15 minutes under stirring.

Then, the mixture was heated at 80° C. and, by a dropping funnel, further 85 g of a solution of hydrogen peroxide 50% by weight in water (aqueous solution B) were added within 30 minutes. Therefore, 250 g of hydrogen peroxide per kg of plant oil derivative in total were added.

At the end of the addition the reaction was left to proceed for further 7 hours by maintaining the temperature at 80° C. under stirring.

After this period of time, the separation of the aqueous phase was carried out by transfer into a separating funnel and settling.

Possible residues of aqueous phase containing hydrogen peroxide in the oily phase were removed through vacuum evaporation by means of rotating evaporator.

A sample of the obtained oily phase was subjected to colorimetric analysis in accordance with the standard method ASTM D 1544-04 and compared with a sample of the same starting oil derivative of plant origin. The Gardner scale level passed from the initial “off the chart” (level exceeding the maximum level of the Gardner scale) to level 18 of said scale, still suitable for applications in fields different from the field of tires.

Therefore, it was demonstrated that the extent of the decoloring effect can be correlated to the amount of oxidizing reagent used.

### EXAMPLE 3 (DECOLORATION TEST OF AN OIL DERIVATIVE OF PLANT ORIGIN HAVING A COLOR OF A LEVEL EXCEEDING THE MAXIMUM LEVEL OF THE GARDNER SCALE, ACCORDING TO THE INVENTION)

In this example the process of example 1 was repeated by using, however, a different plant oil derivative, commercially available under the tradermark Matrilox™ PF801D and having a composition comprised between those of the derivatives described in U.S. Pat. No. 8,969,454, having a color of a level exceeding the maximum level of the Gardner scale (“off the chart” color).

177 g of said oil derivative of plant origin were loaded into a flask of 500 ml, which was equipped with stirring and a thermometer. An aqueous solution previously prepared (aqueous solution A) by mixing under stirring 0.8 g of tungstic acid (0.45% by weight with respect to the total weight of the treated plant oil derivative) and 20 g of hydrogen peroxide 50% by weight in water, was added to it.

In order to promote the homogenization of the reagents, the mixture thus obtained was maintained at 55-60° C. for 15 minutes under stirring.

Then, the mixture was heated at 90° C. and, by means of a dropping funnel, further 70 g of a solution of hydrogen peroxide 50% by weight in water (aqueous solution B) were added within 1 hour. Therefore, 254.5 g of hydrogen peroxide per kg of plant oil derivative in total were added.

At the end of the addition the reaction was left to proceed for further 7 hours by maintaining the temperature at 80° C. under stirring.

After this period of time, the separation of the aqueous phase was carried out by transfer into a separating funnel and settling.

Possible residues of aqueous phase containing hydrogen peroxide in the oily phase were removed by vacuum evaporation by means of a rotating evaporator.

A sample of the obtained oily phase was subjected to colorimetric analysis in accordance with the standard method ASTM D 1544-04 and compared with a sample of the same starting oil derivative of plant origin. The Gardner scale level passed from the initial “off the chart” (level L >18) to level 18 of said scale, suitable for applications in fields different from the field of tires.

### COMPARATIVE EXAMPLES 4-7 (DECOLORATION TESTS OF AN OIL DERIVATIVE OF PLANT ORIGIN IN ACCORDANCE WITH THE METHODS OF THE PRIOR ART)

The results of the decoloration tests of the plant oil derivative Matrilox™ PF801D previously described by some methods described in the known art are reported in the following table. For each experiment the main reagent, the use conditions and the obtained result are indicated. Each reagent was used in accordance with the methods known to the person skilled in the art or following the manufacturer's instructions.

| | | | Result |
|---|---|---|---|
| Example | Reagent | Use conditions | (Gardner scale) |
| 4 | Dried | 80° C./1 hour (in accordance | Negative |
| | Engelhard ® | with the manufacturer's | (off the chart) |
| | earth F24 | instructions) | |
| | BASF | | |
| 5 | Dried | 80° C./1 hour (in accordance | Negative |
| | Engelhard ® | with the manufacturer's | (off the chart) |
| | earth F54 | instructions) | |
| | BASF | | |
| 6 | Dried | 25° C./1 hour (in accordance | Negative |
| | Engelhard ® | with the manufacturer's | (off the chart) |
| | earth F54 | instructions) | |
| | BASF | | |
| 7 | H₂O₂ 30% | 80° C./24 hours (in | Negative |
| | | accordance with the teaching | (off the chart) |
| | | of the prior art) | |

It is evident that none of the tested methods of the prior art are capable of decoloring the oil derivative of plant origin Matrilox™ PF801D so as to bring the level of the Gardner scale to a level lower than or equal to 18, suitable for applications in fields different from the field of tires or bitumens.

### COMPARATIVE EXAMPLES 8-10 (DECOLORATION TESTS OF AN OIL DERIVATIVE OF PLANT ORIGIN IN ACCORDANCE WITH THE METHODS OF THE PRIOR ART)

The results of the decoloration tests of the plant oil derivative Matrilox™ PF801R previously described by some methods described in the prior art are reported in the following table. For each experiment the main reagent, the use conditions and the obtained result are indicated. Each reagent was used in accordance with the methods known to the person skilled in the art or following the manufacturer's instructions.

| | | | Result |
|---|---|---|---|
| Example | Reagent | Use conditions | (Gardner scale |
| 8 | Trisyl ® | 90° C./30 minutes (in | Negative |
| | Grace | accordance with the | (off the chart) |
| | | manufacturer's instructions) | |
| 9 | H₂O₂ 50% | 80° C./24 hours (in | Negative |
| | | accordance with the teaching | (off the chart) |
| | | of the prior art) | |
| 10 | H₂/Pd in | 80° C./5 hours (in accordance | Negative |
| | ethyl | with the teaching of the prior | (off the chart) |
| | acetate | art) | |

It is evident that none of the tested methods of the prior art are capable of decoloring the plant oil derivative Matrilox™ PF801R so as to bring the level of the Gardner scale to a level lower than or equal to 18, suitable for applications in fields different from the field of tires.

It is finally understood that further modifications and variations without departing from the scope of the appended claims can be made to the process herein described and illustrated.

1. A process of decoloration of an oil derivative of plant origin, the process comprising:
i) reacting said oil derivative of plant origin with hydrogen peroxide in the presence of an oxidation catalyst at a temperature in the range of 70° C.-100° C. in order to obtain a mixture comprising an aqueous phase and an oily phase; and
ii) separating from said mixture the aqueous phase and the oily phase, the latter comprising a decolored oil derivative of plant origin.

2. The process according to claim 1, wherein the reacting i) is carried out for a time period between 5 and 12 hours.

3. The process according to claim 1, wherein the reacting i) comprises:
a) contacting said oil derivative of plant origin with an aqueous solution A comprising hydrogen peroxide, in the presence of an oxidation catalyst;
b) bringing the mixture obtained in the contacting a) to a temperature in the range of 70° C.-100° C.;
c) adding an aqueous solution B comprising hydrogen peroxide to the mixture obtained in b); and
d) maintaining the mixture obtained in the adding c) at a temperature within the range of 70° C.-100° C. for a time period between 5 and 12 hours.

4. The process according to claim 3, wherein the reacting i) and/or from a) to d) are carried out under stirring.

5. The process according to claim 3, wherein all the reacting (i) and the separating (ii) and/or a) to d) are carried out without adding organic solvents.

6. The process according to claim 1, wherein said oil derivative of plant origin has a color of a level exceeding the maximum level of the Gardner scale.

7. The process according to claim 1, wherein when said oil derivative of plant origin has a color of a level exceeding the maximum level of the Gardner scale, and the color of said decolored derivative at the end of the process is of a level lower than or equal to level 18 of the Gardner scale.

8. The process according to claim 1, wherein said oil derivative of plant origin comprises one or more from the following:
a) a mixture of triglicerides comprising one or more of the following oligomeric structures:
R₄[O—C(O)—R₁—C(O)—O—CH₂—CH(OR₂)—CH₂]ₙ—O—R₃,
wherein R₁ is a C₂-C₂₂ alkylene, R₂ is selected from C₆-C₂₄ monocarboxylic acid residues or C₆-C₂₄ dicarboxylic acid residues, R₃ is selected from H, C₆-C₂₄ dicarboxylic acid residues and C₆-C₂₄ monocarboxylic acid residues, R₄ is an alkyl group, n is an integer higher than or equal to 2, wherein said C₆-C₂₄ dicarboxylic acid residues of R₂ and R₃, are esterified with monoalcohols, and wherein said mixture of triglycerides has a Number Average Molar Mass (Mn) between 800 and 10000;
b) triglycerides of one or more long-chain carboxylic acids comprising at least one carboxylic acid containing adjacent hydroxyl groups;
c) esters of polyols with at least one C₆-C₂₄ monocarboxylic acid and at least one C₆-C₂₄ dicarboxylic acid, said esters being different from the triglycerides.

9. The process according to claim 3, wherein the contacting a) is carried out at atmospheric pressure and at a temperature in the range of 40° C.-65° C.

10. The process according to claim 3, wherein during the contacting a) of said process, said oil derivative of plant origin is contacted with said aqueous solution A for a time period between 10 minutes and 1 hour.

11. The process according to claim 1, wherein said oxidation catalyst is selected from the group consisting of tungstic acid and phosphotungstic acid.

12. The process according to claim 1, wherein said catalyst is used in an amount between 0.05% and 3% by weight with respect to the total weight of the oil derivative of plant origin to be decolored.

13. The process according to claim 3, wherein during the adding c), the addition of aqueous solution B is carried out in a period of time period between 20 minutes and 5 hours.

14. The process according to claim 3, wherein the maintaining d) is carried out for a time period between 6 and 10 hours.

15. The process according to claim 3, wherein the maintaining d) is carried out at a temperature between 80° C. and 95° C.

16. The process according to claim 1, wherein the oily phase separated in the separating ii) consists of a decolored oil derivative of plant origin.

17. A derivative of oil of plant origin decolored through the process of decoloration according to claim 1.

18. The derivative of oil of plant origin according to claim 17, having a color of a level equal to or lower than level 18 of the Gardner scale.

19. An oil derivative of plant origin comprising one or more from the following:
a) a mixture of triglycerides comprising one or more of the following oligomeric structures:
R₄[O—C(O)—R₁—C(O)—O—CH₂—CH(OR₂)—CH₂]ₙ—O—R₃,
wherein R₁ is a C₂-C₂₂ alkylene, R₂ is selected from C₆-C₂₄ monocarboxylic acid residues or C₆-C₂₄ dicarboxylic acid residues, R₃ is selected from H, C₆-C₂₄ dicarboxylic acid residues and C₆-C₂₄ monocarboxylic acid residues, R₄ is an alkyl group, n is an integer higher than or equal to 2, wherein said C₆-C₂₄ dicarboxylic acid residues of R₂ and R₃, are esterified with monoalcohols, and wherein said mixture of triglycerides has a Number Average Molar Mass (Mn) between 800 and 10000;
b) triglycerides of one or more long-chain carboxylic acids comprising at least one carboxylic acid containing adjacent hydroxyl groups;
c) esters of polyols with at least one C₆-C₂₄ monocarboxylic acid and at least one C₆-C₂₄ dicarboxylic acid, said esters being different from the triglycerides,
wherein the oil derivative has a color of a level lower than or equal to level 18 of the Gardner scale.
